(19) United States
(12) Patent Application Publication
(10) Pub. No.: US 2020/0052272 A1
(43) Pub. Date: Feb. 13, 2020

(54) POROUS FILM, SEPARATOR COMPRISING THE POROUS FILM, AND ELECTROCHEMICAL DEVICE COMPRISING THE POROUS FILM

(71) Applicant: Samsung Electronics Co., Ltd., Suwon-si (KR)

(72) Inventors: Kitae Park, Seoul (KR); Jinkyu Kang, Hwaseong-si (KR); Hyun Chul Lee, Hwaseong-si (KR); Hyeokjo Gwon, Hwaseong-si (KR); Nagjong Kim, Suwon-si (KR); Sunghaeng Lee, Seoul (KR)

(21) Appl. No.: 16/446,995

(22) Filed: Jun. 20, 2019

(30) Foreign Application Priority Data
Aug. 9, 2018 (KR) 10-2018-0093344

(51) Int. Cl. H01M 2/16; H01M 10/0525; H01M 10/0587

(52) U.S. Cl. CPC H01M 2/1626; H01M 10/0587; H01M 10/0525; H01M 2/1653

(57) ABSTRACT

A porous film comprising a Lewis base and nanofibers comprising cellulose or a derivative thereof, a separator comprising the porous film, and an electrochemical device comprising the separator or porous film are provided. The electrochemical device comprising the separator comprising the porous film may have improved thermal stability, and thus deterioration of the electrochemical device may be inhibited.

### CROSS-REFERENCE TO RELATED APPLICATION

This application claims the benefit of Korean Patent Application No. 10-2018-0093344, filed on Aug. 9, 2018, in the Korean Intellectual Property Office, the entire disclosure of which is hereby incorporated by reference.

### BACKGROUND

### 1. Field

The present disclosure relates to a porous film, a separator comprising the porous film, and an electrochemical device comprising the separator or porous film, and more particularly, to a cellulose porous film having improved thermal stability, a separator comprising the cellulose porous film, and an electrochemical comprising the separator or cellulose porous film.

### 2. Description of the Related Art

Electrochemical batteries such as lithium secondary batteries use a separator which separates a positive electrode from a negative electrode to prevent short circuits. The separator needs to be resistant to an electrolyte and have low internal resistance. In recent years, the demand for electrochemical batteries having high thermal resistance has increased in order to use the electrochemical batteries in vehicles. Polyolefin-based porous films formed from polyethylene or polypropylene have been used as separators in lithium secondary batteries. However, it is difficult to apply the polyolefin-based separator to a battery for a vehicle since thermal resistance is required at a temperature of 150° C. or higher.

Cellulose nanofibers (CNF) obtained from cellulose are ultra-fine fibers having nano-scale diameters and, due to their excellent mechanical properties and low thermal expansion coefficient, have received attention as a material for separators of lithium secondary batteries.

When a CNF nonwoven fabric is used as a separator of a lithium secondary battery, resistance of the separator is lower than polymer-based separators commonly used in the art due to high wetting properties of CNF. Therefore, a battery comprising such a separator may have high power output and a long lifespan. In addition, the shape of the separator may be maintained even at a temperature of 250° C. or higher due to a low thermal expansion coefficient of CNF, and thus ignition caused by a short-circuit of the separator may be prevented. Due to these properties, CNF has drawn attention as a material used to form the separator.

However, using a separator comprising a CNF nonwoven fabric known in the art still provides disadvantages. For example, the separator may be affected by various reactive active materials in lithium secondary batteries due to a plurality of hydroxyl groups and carboxyl groups present on the surface of CNF and inter- and intra-molecular hydrogen bonds between polysaccharide chains. Particularly, such reactions are accelerated at a high temperature, thereby affecting stability of the CNF separator.

Thus, there is a need for cellulose-containing porous films having chemical thermal resistance as well as physical thermal resistance.

### SUMMARY

Provided herein is a porous film comprising a Lewis base and nanofibers comprising cellulose or a derivative thereof.

Also provided is a separator comprising the porous film.

Further provided is an electrochemical device comprising a positive electrode, a negative electrode, and the separator or porous film interposed between the positive electrode and the negative electrode.

Also provided is a method of preparing a porous film comprising binding a Lewis base to a non-woven fabric comprising nanofibers of cellulose or a derivative thereof.

Additional aspects will be set forth in part in the description which follows and, in part, will be apparent from the description, or may be learned by practice of the presented embodiments.

### BRIEF DESCRIPTION OF THE DRAWINGS

These and/or other aspects will become apparent and more readily appreciated from the following description of the embodiments, taken in conjunction with the accompanying drawings in which:

FIG. 1 shows photographs of a CNF porous film, and illustrates carbonization thereof with or without an electrolyte (EL) and/or LiPF₆;

FIG. 2 shows photographs of a CNF porous film as described in Example 1, and illustrates thermal deformation test results thereof;

FIG. 3 shows photographs of a CNF porous film as described in Example 2, and illustrates thermal deformation test results thereof;

FIG. 4 is a graph illustrating thermomechanical analysis (TMA) results of a CNF porous film as described in Example 3;

FIG. 5 is a graph illustrating TMA results of CNF porous films as described in Examples 4 and 5;

FIGS. 6A-6i are schematic cross-sectional views of porous films according to certain embodiments; and

FIG. 7 is a diagram schematically illustrating a lithium battery comprising the porous film according to one embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects.

The terms used herein are merely used to describe particular embodiments, and are not intended to limit the present disclosure. An expression used in the singular encompasses the expression of the plural, unless it has a clearly different meaning in the context. Hereinafter, it is to be understood that terms such as “including,” “having,” “comprising,” etc., are intended to indicate the existence of features, numbers, operations, components, parts, elements, materials, or combinations thereof disclosed in the specification, and are not intended to preclude the possibility that one or more other features, numbers, operations, components, parts, elements, materials, or combinations thereof may exist or may be added. As used herein, the term “and/or” includes any and all combinations of one or more of the associated listed items. Expressions such as “at least one of,” when preceding a list of elements, modify the entire list of elements and do not modify the individual elements of the list.

In the drawings, thicknesses of layers and regions are not necessarily drawn to scale and may be enlarged or reduced for clarity. Throughout the specification, like reference numerals denote like elements. Throughout the specification, it will be understood that when one element such as layer, region, or plate, is referred to as being “on” another element, such element may be directly on the other element, or intervening elements or layers may also be present there between (i.e., separating the other elements or layers). It will be understood that, although the terms first, second, etc. may be used herein to describe various components, these components should not be limited by these terms. These terms are only used to distinguish one component from another.

Hereinafter, a porous film, a separator comprising the porous film, and an electrochemical device both including the porous film or separator, will be described in further detail.

A porous film according to one embodiment includes a Lewis base and nanofibers including cellulose or a derivative thereof.

Cellulose is one of the most abundant polymer substances present in nature, and nanofibers including cellulose or a derivative thereof (hereinafter, referred to as cellulose nanofibers or “CNF”) are ultra-fine fibers having nano-scale diameters with excellent mechanical properties and a low thermal expansion coefficient.

An exemplary porous film is obtained by drying a composition including the plurality of cellulose nanofibers such that the cellulose nanofibers are bound or twisted together. Thus, the porous film of the present disclosure may have a different structure from that of a web-like, nonwoven fabric porous film well known in the art, which are generally formed from a composition in which a polymer resin is dissolved by a non-solvent, by electric field radiation, or the like.

For example, the CNF of the present disclosure may include natural cellulose such as plant CNF, animal CNF, and/or microbial CNF. For example, the CNF may be wood pulp such as softwood pulp or hardwood pulp; cotton pulp such as cotton linter; non-wood pulp such as wheat straw pulp or bagasse pulp; bacterial cellulose; cellulose separated from Ascidiacea; cellulose isolated from seaweed; or the like. Since the CNF of the disclosure has excellent thermal resistance, a porous film including the CNF has excellent thermal resistance.

In certain embodiments, the CNF may be, for example, carboxyl group-containing CNF. For example, a carboxyl group included in the CNF may be covalently bound to a carbon atom that is part of a pyranose ring. The carboxyl group may be provided by a group of Formula 1 or 2 below.

—R₁—O—R₂—COOM Formula 1

—O—R₂—COOM Formula 2

In Formulae 1 and 2, R₁ and R₂ may each independently be a substituted or unsubstituted C1-C10 alkylene group (i.e., divalent alkyl), and M may be a hydrogen or an alkali metal. For example, the alkali metal may be lithium, sodium, potassium, or the like. For example, R₁ and R₂ may each independently be a methylene group. For example, the carboxyl group in the carboxyl group-containing CNF, which is bound to the carbon atom that is part of the pyranose ring, may be provided by —CH₂OCH₂COONa or —OCH₂COONa. For example, the pyranose ring may be glucopyranose.

Thus, the carboxyl group included in the carboxyl group-containing CNF and represented by Formula 1 or 2, wherein the carboxyl group having a —COOM structure is bound to a carbon that is part of a pyranose ring via —R₁—O—R₂— linking group or —O—R₂-linking group, has a different structure from that of a carboxyl group having a —COOM structure directly bound to a carbon atom that is part of a pyranose ring without a linking group, as found in oxidized CNF obtained by chemical oxidation used in the related art.

In one embodiment, an amount of the carboxyl group of the carboxyl group-containing CNF is about 0.02 mmol/g or greater, about 0.06 mmol/g or greater, about 0.10 mmol/g or greater, about 0.15 mmol/g or greater, or about 0.20 mmol/g or greater. For example, the amount of the carboxyl group of the carboxyl group-containing CNF included in the porous film may be from about 0.02 mmol/g to about 10 mmol/g, from about 0.02 mmol/g to about 5 mmol/g, from about 0.02 mmol/g to about 3 mmol/g, from about 0.02 mmol/g to about 2 mmol/g, or from about 0.02 mmol/g to about 1 mmol/g. When the CNF includes the carboxyl group-containing CNF having the carboxyl group within the ranges described above, the porous film including the same provides improved tensile strength and improved tensile modulus. The amount of the carboxyl group of the CNF may be measured by conductometric titration or ion chromatography.

In some embodiments, the carboxyl group-containing CNF may have an average diameter of about 100 nm or less, about 80 nm or less, about 60 nm or less, about 50 nm or less, about 45 nm or less, about 40 nm or less, about 35 nm or less, about 30 nm or less, or about 25 nm or less. For example, the CNF included in the porous film may have an average diameter of from about 1 nm to about 100 nm, from about 1 nm to about 80 nm, from about 1 nm to about 60 nm, from about 1 nm to about 50 nm, from about 1 nm to about 45 nm, and from about 5 nm to about 45 nm. When the porous film includes the carboxyl group-containing CNF having the average diameter within the ranges above, tensile strength of the porous film may further be improved. The average diameter of the carboxyl group-containing CNF refers to an average of the diameters of 100 carboxyl group-containing fibers arithmetically calculated by analyzing transmission electron microscope (TEM) images of fibers using an image analyzer.

In a diameter distribution curve of the carboxyl group-containing CNF, a full width at half maximum (FWHM) of a diameter peak may be, for example, about 50 nm or less, about 45 nm or less, about 40 nm or less, about 35 nm or less, about 30 nm or less, about 25 nm or less, about 20 nm or less, about 15 nm or less, or about 10 nm or less. In the diameter distribution curve of the carboxyl group-containing CNF, the FWHM of the diameter may be, for example, from about 1 nm to about 45 nm, from about 5 nm to about 45 nm, or from about 10 nm to about 45 nm. A porous film including the carboxyl group-containing CNF having such a FWHM as described above may have improved tensile strength due to improvement of uniformity of the porous film and an increase in the number of contact points between fibers.

In one embodiment, the carboxyl group-containing CNF may be a microbial or bacterial CNF including a carboxyl group. That is, the carboxyl group-containing microbial CNF may be a fermentation product of a culture comprising microorganisms, such that the carboxyl-group containing microbial CNF may be directly obtained from the culture comprising the microorganisms. Thus, the carboxyl group-containing CNF included in the porous film may be distinguished from a mixture of microbial CNFs and a carboxyl group-containing compound used in the related art. Also, the carboxyl group-containing microbial CNF of the present disclosure may also be distinguished from a wood CNF obtained by decomposing wood materials.

The carboxyl group-containing microbial CNF of the present disclosure may be obtained by using a microorganism derived from the genus Enterobacter, Gluconacetobacter, Komagataeibacter, Acetobacter, Achromobacter, Agrobacterium, Alcaligenes, Azotobacter, Pseudomonas, Rhizobium, Sarcina, Klebsiella, or Escherichia, but embodiments are not limited thereto, and any microorganism available in the art capable of producing microbial cellulose may be used to obtain the CNF of the present disclosure. For example, a microorganism of the genus Acetobacter may be Actetobacter pasteurianus. For example, a microorganism of the genus Agrobacterium may be Agrobacterium tumefaciens. For example, a microorganism of the genus Rhizobium may be Rhizobium leguminosarum. For example, a microorganism of the genus Sarcina may be Sarcina ventriculi. For example, a microorganism of the genus Gluconacetobacter may be Gluconacetobacter xylinum. For example, a microorganism of the genus Klebsiella may be Klebsiella pneumoniae. For example, a microorganism of the genus Escherichia may be E. coli.

The carboxyl group-containing microbial cellulose may have an absorption peak corresponding to a carboxyl group at about 1572 cm⁻¹ in an IR spectrum. A microbial cellulose not including a carboxyl group does not have the absorption peak.

A porous film of the present disclosure may further include any other CNF used in the related art in addition to the microbial CNF described herein. For example, the porous film may further include wood CNF, but the embodiment is not limited thereto, and any CNF capable of improving a tensile strength of a separator available in the art may also be used.

In some embodiments of the present disclosure, the amount of the CNF included in the porous film may be about 1 wt % or greater, about 5 wt % or greater, about 10 wt % or greater, about 20 wt % or greater, about 30 wt % or greater, about 40 wt % or greater, about 50 wt % or greater, about 60 wt % or greater, about 70 wt % or greater, about 80 wt % or greater, or about 90 wt % or greater based on a total weight of the porous film. The amount of the CNF included in the porous film may be, for example, from about 1 wt % to about 100 wt %, from about 5 wt % to about 100 wt %, from about 10 wt % to about 99 wt %, from about 20 wt % to about 95 wt %, from about 30 wt % to about 95 wt %, from about 40 wt % to about 95 wt %, or from about 50 wt % to about 90 wt % based on the total weight of the porous film. When the porous film includes the CNF in the ranges described above, thermal stability of the porous film may further be improved.

In certain embodiments, the porous film of the present disclosure includes a Lewis base.

A Lewis base is a compound comprising a functional group in which an atom having an unshared electron pair is used as an electron pair donor. For example, the Lewis base of the present disclosure may be at least one selected from hexamethylphosphoramide (HMPA), tris(2,2,2-trifluoroethyl) phosphate (TTFP), polyethylene glycol (PEG), polyethylenimine (PEI), poly(vinyl acetate) (PVAc), N,N-dimethylacetamide (DMAc), hexamethoxycyclotriphosphazene (HMPN), pyridine, dimethylsulfoxide (DMSO), N-methyl-2-pyrrolidione, N-methyl-2-pyridine, 2,6-dimethyl-γ-pyrone, acetamide, urea, thiourea, N,N-dimethylthioacetamide, thioacetamide, ethylenediamine, tetramethylethylenediamine, 2,2′-bipyridine, 1,10-piperidine, aniline, pyrrolidine, diethylamine, N-methylpyrrolidine, n-propylamine, and any derivative thereof.

The Lewis base may be chemically or physically bound to nanofibers comprising cellulose or a derivative thereof.

The Lewis base may prevent deformation of the CNF caused by carbonization at a high temperature by stabilizing highly reactive by-products that may be generated in electrochemical devices.

For example, when a lithium secondary battery is exposed to a high temperature, lithium hexafluorophosphate (LiPF₆), commonly used as a lithium salt, may be decomposed by heat to generate highly reactive substances such as PF₅ or HF. Mechanisms of thermal decomposition of LiPF₆ and reactions between LiPF₆ and moisture may be expressed as follows.

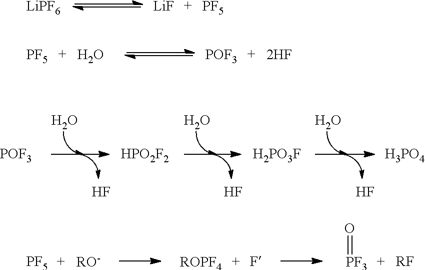

The RO⁻ that may be generated in this process may also react with the CNF.

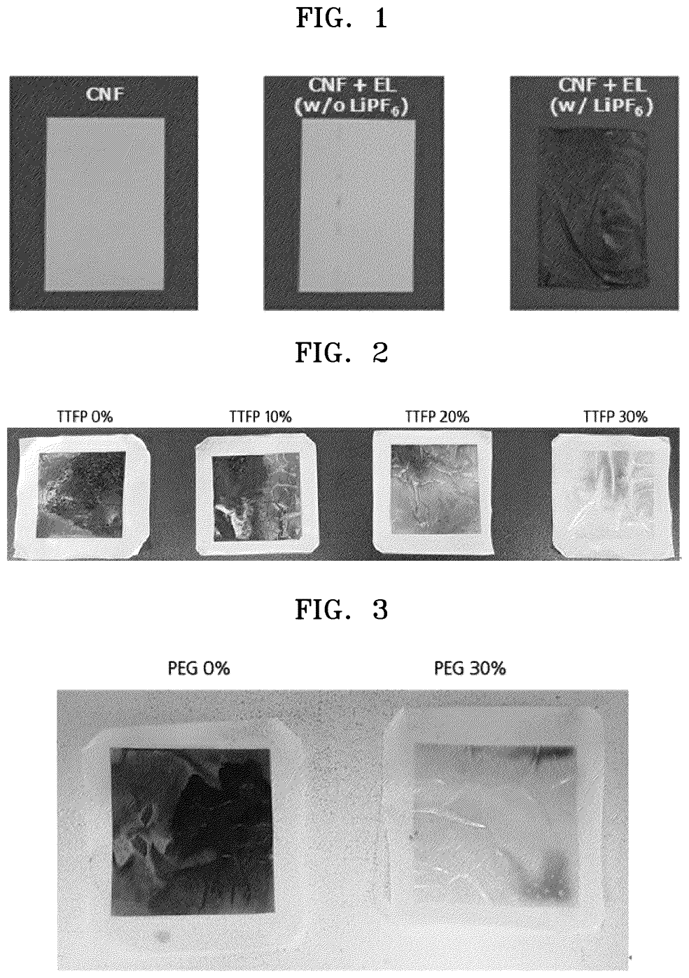

When a CNF porous film of the present disclosure is immersed in an electrolyte and treated at a high temperature of 170° C. for 3 hours, carbonization of CNF generally occurs only when the electrolyte comprises LiPF₆, as illustrated in FIG. 1. For example, FIG. 1 shows that carbonization of the porous film generally does not occur when the CNF porous film is treated at a high temperature of 170° C. for 3 hours absent immersion in an electrolyte, or when the CNF porous film is immersed in an electrolyte that does not comprise LiPF₆. This confirms that substances generated from thermal decomposition of LiPF₆ can cause carbonization of CNF.

However, when the Lewis base such as pyridine or HMPA is introduced thereto, the Lewis base binds to PF₅, and thus further reaction from PF₅ may be prevented. The Lewis base may form a complex with PF₅ or another decomposition product of LiPF₆.

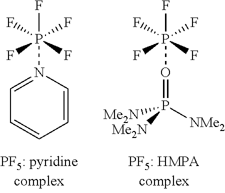

As described above, the porous film may prevent deformation of CNF caused by LiPF₆ at a high temperature by including the Lewis base, which will be further demonstrated by the Examples of the present disclosure.

The Lewis base may be chemically or physically bound to the cellulose or the derivative thereof. In one embodiment of the porous film, the functional group (moiety) of the Lewis base may be conjugated with the CNF via surface reformation of the CNF to form a chemical bond. In one embodiment of the porous film, the CNF and a molecule of the Lewis base are bonded by hydrogen bonding or van der Waals bonding, or a polymeric component of the Lewis base is entangled with the CNF to form a physical bond. The chemical or physical bond may be analyzed using any analysis method known in the art such as Auger Electron Spectroscopy (AES), X-ray Photoelectron Spectroscopy (XPS), and Secondary Ion Mass Spectroscopy (SIMS).

The Lewis base may directly be introduced into the CNF to prepare the porous film. Alternatively, after preparing a porous film including the CNF, a solution including the Lewis base may be added thereto, thereby preparing the porous film including both the Lewis base and the CNF.

The porous film may further include an electrolyte comprising a lithium salt.

The lithium salt may include at least one selected from LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, (CF₃SO₂)₂NLi, lithium chloroborate, lower aliphatic lithium carboxylate, lithium tetraphenyl borate, and lithium imide, without being limited thereto, such that any compound available as a lithium salt in the art may also be used.

In one embodiment, the porous film may include LiPF₆ as the lithium salt.

The electrolyte may be a liquid electrolyte.

The liquid electrolyte may be prepared by dissolving the lithium salt in an organic solvent.

The organic solvent may be any solvent available as an organic solvent in the art. Examples of the organic solvent may include, but is not limited to, propylene carbonate, ethylene carbonate, fluoroethylene carbonate, butylene carbonate, dimethyl carbonate, diethyl carbonate, methylethyl carbonate, methylpropyl carbonate, ethylpropyl carbonate, methylisopropyl carbonate, dipropyl carbonate, dibutyl carbonate, benzonitrile, acetonitrile, tetrahydrofuran, 2-m ethyltetrahydrofuran, γ-butyrolactone, dioxorane, 4-methyldioxorane, N,N-dimethyl formamide, dimethyl acetamide, dimethylsulfoxide, dioxane, 1,2-dimethoxyethane, sulforane, dichloroethane, chlorobenzene, nitrobenzene, diethylene glycol, dimethyl ether, or a mixture thereof.

In certain embodiments, the porous film may further include at least one selected from a cross-linking agent, a binder, inorganic particles, polyamide nanofiber, polyolefin, heat-resistant aramid fiber, or heat-resistant polymer having an elongation property such as polyimide, polyethylene terephthalate (PET), polyacrylonitrile (PAN), and polyvinylidene difluoride (PVDF), in addition to the CNF. When the porous film additionally includes any one of these components, physical properties, such as tensile strength, of the porous film may easily be controlled.

When the porous film further includes a cross-linking agent and/or a binder, the tensile strength of the porous film may be further improved.

For example, the cross-linking agent assists the binding between the fibrils of the CNF. An amount of the cross-linking agent may be in a range of about 1 part by weight to about 50 parts by weight based on 100 parts by weight of the CNF. However, the embodiment is not limited thereto, and any amount of the cross-linking agent capable of improving physical properties of the porous film may also be used. For example, the amount of the cross-linking agent may be from about 1 part by weight to about 30 parts by weight, from about 1 part by weight to about 20 parts by weight, or from about 1 part by weight to about 15 parts by weight based on 100 parts by weight of the CNF. For example, the cross-linking agent may include at least one selected from isocyanate, polyvinyl alcohol, and polyamide epichlorohydrin (PAE). However, the embodiment is not limited thereto, and any material available as a cross-linking agent in the art may also be used.

The binder assists with the binding between fibrils of the CNF. An amount of the binder may be from about 1 part by weight to about 50 parts by weight based on 100 parts by weight of the CNF. However, the embodiment is not limited thereto, and any amount capable of improving physical properties of the porous film may also be used. For example, the amount of the binder may be from about 1 part by weight to about 30 parts by weight, from about 1 part by weight to about 20 parts by weight, or from about 1 part by weight to about 15 parts by weight based on 100 parts by weight of the CNF. For example, the binder may include at least one selected from cellulose single nanofiber, methyl cellulose, hydroxypropyl methylcellulose, hydroxyethyl methyl cellulose, carboxyl methyl cellulose, ethyl cellulose, polyvinylidene fluoride-co-hexafluoropropylene, polyvinylidene fluoride-co-trichloroethylene, polymethylmethacrylate, polyacrylonitrile, polyvinylpyrrolidone, polyvinylacetate, polyethylene-co-vinyl acetate, polyimide, polyethylene oxide, cellulose acetate, cellulose acetate butyrate, cellulose acetate propionate, cyanoethylpullulan, cyanoethylpolyvinylalcohol, cyanoethylcellulose, cyanoethylsucrose, pullulan, and polyvinylalcohol. However, the embodiment is not limited thereto, and any material available as a binder in the art may also be used.

The inorganic particles of the present disclosure may improve mechanical properties of the porous film.

Examples of the inorganic particles may include: a metal oxide selected from alumina (Al₂O₃), silica (SiO₂), titania (TiO₂), HfO₂, SrTiO₃, SnO₂, CeO₂, Na₂O, MgO, NiO, CaO, BaO, ZnO, ZrO₂, Y₂O₃, BaTiO₃, Li₂O, RaO, CaO, SrO, Sc₂O₃, Ce₂O₃, and cage-structured silsesquioxane; a metal nitride selected from ZrN, TaN, HfN, VN, NbN, Cr₂N, TaN, CrN, GeN, TLi₃N, Mg₃N₂, Ca₃N₂, Sr₃N₂, Ba₃N₂, BN, AlN, and TiN; a metal oxynitride selected from tantalum oxynitride (TaON), zirconium oxynitride (ZrOₓN_{y}, where 0<x<2 and 0<y<3,), and lithium phosphorus oxynitride (LiPON); a metal carbide selected from TiC, ZrC, HfC, NbC, TaC, Cr₃C₂, Mo₂C, WC, and SiC; a metal-organic framework (MOF); a lithiated compound thereof; a ceramic conductor selected from Li_{1+x+y}AlₓTi₂₋ₓSi_{y}P_{3-y}O₁₂ (0<x<2 and 0≤y<3), BaTiO₃, Pb(Zr,Ti)O₃(PZT), Pb₁₋ₓLaₓZr_{1-y}Ti_{y}O₃ (PLZT, where 0≤x<1 and 0≤y<1), Pb(Mg₃Nb_{2/3})O₃—PbTiO₃ (PMN-PT), lithium phosphate (Li₃PO₄), lithium titanium phosphate (LiₓTi_{y}(PO₄)₃, where 0<x<2 and 0<y<3), lithium aluminum titanium phosphate (LiₓAl_{y}Ti_{z}(PO₄)₃, where 0<x<2, 0<y<1, and 0<z<3), Li_{1+x+y}(Al, Ga)ₓ(Ti, Ge)₂₋ₓSi_{y}P_{3-y}O₁₂ (0≤x≤1 and 0≤y≤1), lithium lanthanum titanate (LiₓLa_{y}TiO₃, where 0<x<2 and 0<y<3), lithium germanium thiophosphate (LiₓGe_{y}P_{z}S_{w}, where 0<x<4, 0<y<1, 0<z<1, and 0<w<5), lithium nitride (LiₓN_{y}, where 0<x<4 and 0<y<2), a SiS₂ glass (LiₓSi_{y}S_{z}, where 0<x<3, 0<y<2, and 0<z<4), a P₂S₅ glass (LiₓP_{y}S_{z}, where 0<x<3, 0<y<3, and 0<z<7), a Li₂O—Al₂O₃—SiO₂—P₂O₅—TiO₂—GeO₂ ceramic, and a garnet ceramic (Li₃₊ₓLa₃M₂O₁₂, where 0≤x≤5, and M=Te, Nb, or Zr); a carbonaceous nanostructure such as graphene, carbon nanotube (CNT), or carbon nanofiber. However, the embodiment is not limited thereto, and any inorganic particles of separators available in the art may also be used. The inorganic particles may have a diameter of from about 1 nm to about 10 μm.

The polyamide nanofiber of the present disclosure may improve tensile strength of the porous film.

Examples of the polyamide nanofiber may include, but are not limited to, aramid nanofiber and nylon nanofiber, and any polyamide nanofiber commonly used in the art may also be used.

Polyolefin may also improve flexibility of the porous film of the present disclosure.

Examples of polyolefin include polyethylene and polypropylene, but is not limited thereto. For example, polyolefin may form a single layer film or a multilayer film having two or more layers. For example, polyolefin may form a polyethylene/polypropylene double-layered film, a polyethylene/polypropylene/polyethylene triple-layered film, or a polypropylene/polyethylene/polypropylene triple-layered film. However, the embodiment is not limited thereto, and any material available in the art as polyolefin may also be used.

For example, a contact angle of the porous film with water at 20° C. may be about 60° or less, about 50° or less, about 40° or less, about 30° or less, or about 20° or less. Since the porous film has a low contact angle with a polar solvent such as water, the porous film may have improved wettability by an electrolyte including the polar solvent. When the porous film has an excessively large contact angle with water at 20° C., it is difficult to impregnate the electrolyte into the porous film. Accordingly, when the porous film of the present disclosure is used as a separator of a lithium battery, the porous film may have improved wettability by the electrolyte, and thus the electrolyte may be uniformly impregnated into an interface between the separator and an electrode. Therefore, electrode reactions may uniformly be performed at the interface between the separator and the electrode, such that formation of lithium dendrites caused by local over current may be prevented, thereby improving the lifespan of the electrochemical device.

The porous film of the present disclosure may have a heat shrinkage of about 5% or less, about 4.5% or less, about 4% or less, about 3.5% or less, about 3% or less, about 2.5% or less, about 2% or less, about 1.5% or less, or about 1% or less after being maintained at 150° C. for 30 minutes. Since the porous film provides excellent thermal stability at a high temperature of 150° C. or higher, the electrochemical device including the porous film as a separator may have improved thermal resistance. Olefin-based porous films used in the related art rapidly shrink at a high temperature in the range of from about 150° C. to about 200° C., thereby stopping the operation of batteries.

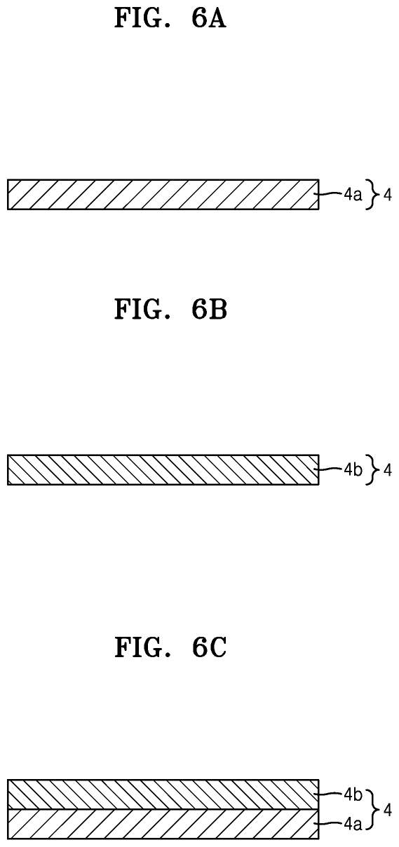

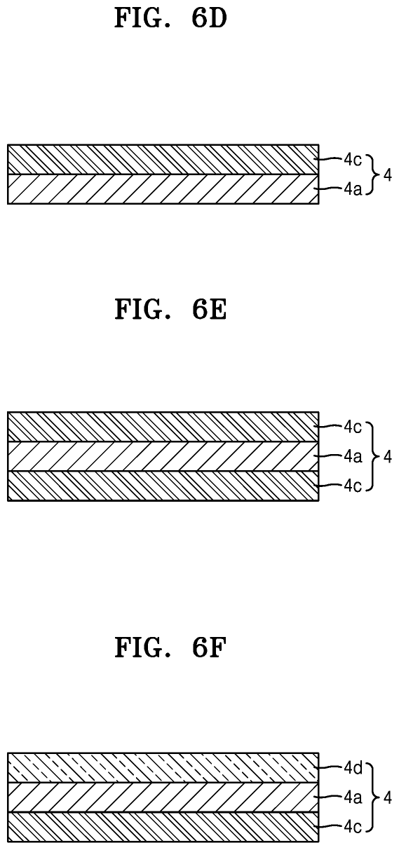

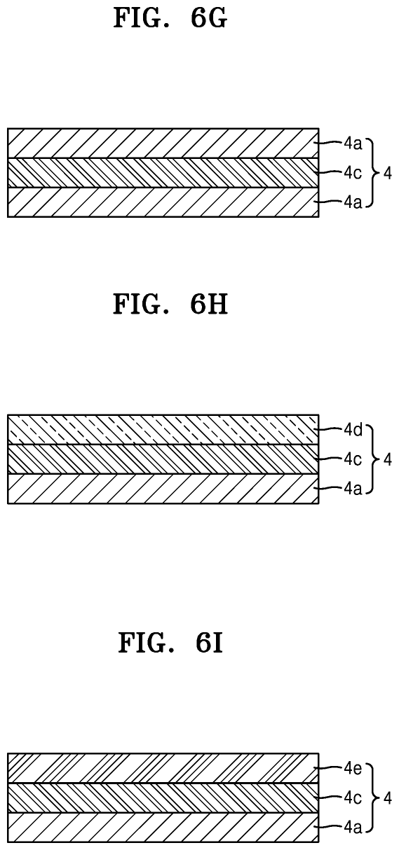

The porous film may have various single-layered or multi-layered structures according to performance to be formed. Some embodiments of porous films having single-layered or multi-layered structures according to the present disclosure are described with reference to FIG. 6A to 6I.

Referring to FIG. 6A, a porous film (4) may have a single-layered structure including a first layer (4a) including a first CNF. For example, the first layer (4a) may include a microbial CNF, as the first CNF.

Referring to FIG. 6B, the porous film (4) may have a single-layered structure including a second layer (4b) including the first CNF and a second CNF different from the first CNF. For example, the second layer (4b) may include a microbial CNF, as the first CNF, and a CNF obtained from Broussonetia kazinoki Siebold, as the second CNF.

Referring to FIG. 6C, the porous film (4) may have a multi-layered structure including: the first layer (4a) including the first CNF; and the second layer (4b) located on one surface of the first layer (4a) and including the first CNF and the second CNF. For example, both the first layer (4a) and the second layer (4b) may include a microbial CNF, as the first CNF, and the second layer (4b) may further include the CNF obtained from Broussonetia kazinoki Siebold, as the second CNF.

Referring to FIG. 6D, the porous film (4) may have a multi-layered structure including: the first layer (4a) including the first CNF; and a third layer (4c) located on one surface of the first layer (4a) as a first CNF-free layer. For example, the first layer (4a) may include a microbial CNF, as the first CNF, and the third layer (4c) may include, but is not limited to, at least one selected from a cross-linking agent, a binder, inorganic particles, inorganic fiber, polyamide nanofiber, and polyolefin, or any other materials in the art commonly used to form the porous film.

Referring to FIG. 6E, the porous film (4) may have a multi-layered structure including: the first layer (4a) including the first CNF; the third layer (4c) located on one surface of the first layer (4a) as a first CNF-free layer; and the third layer (4c) located on the other surface of the first layer (4a) as a first CNF-free layer. For example, the first layer (4a) may include a microbial CNF, as the first CNF, and the third layer (4c) may include, but is not limited to, at least one selected from a cross-linking agent, a binder, inorganic particles, inorganic fiber, polyamide nanofiber, and polyolefin, or any other materials in the art commonly used to form the porous film.

Referring to FIG. 6F, the porous film (4) may have a multi-layered structure including: the first layer (4a) including the first CNF; the third layer (4c) located on one surface of the first layer (4a) as a first CNF-free layer; and a fourth layer (4d) located on the other surface of the first layer (4a) as a second CNF-free layer having a composition different from that of the third layer (4c). For example, the first layer (4a) may include a microbial CNF, as the first CNF, and the third layer (4c) and the fourth layer (4d) may each independently include, but are not limited to, at least one selected from a cross-linking agent, a binder, inorganic particles, inorganic fiber, polyamide nanofiber, and polyolefin, or any other materials in the art commonly used to form the porous film.

Referring to FIG. 6G, the porous film (4) may have a multi-layered structure including: the third layer (4c) that is a first CNF-free layer; the first layer (4a) located on one surface of the third layer (4c) and including the first CNF; and the first layer (4a) located on the other surface of the third layer (4c) and including the first CNF. For example, the first layer (4a) may include a microbial CNF, as the first CNF, and the third layer (4c) may include, but is not limited to, at least one selected from a cross-linking agent, a binder, inorganic particles, inorganic fiber, polyamide nanofiber, and polyolefin, or any other materials in the art commonly used to form the porous film.

Referring to FIG. 6H, the porous film (4) may have a multi-layered structure including: the third layer (4c) that is a first CNF-free layer; the first layer (4a) located on one surface of the third layer (4c) and including the first CNF; and the fourth layer (4d) located on the other surface of the third layer (4c) as a second CNF-free layer having a composition different from that of the third layer (4c). For example, the first layer (4a) may include a microbial CNF, as the first CNF, and the third layer (4c) and the fourth layer (4d) may each independently include, but are not limited to, at least one selected from a cross-linking agent, a binder, inorganic particles, inorganic fiber, polyamide nanofiber, and polyolefin, or any other materials in the art commonly used to form the porous film.

Referring to FIG. 6I, the porous film (4) may have a multi-layered structure including: the third layer (4c) that is a first CNF-free layer; the first layer (4a) located on one surface of the third layer (4c) and including the first CNF; and a fifth layer (4e) located on the other surface of the third layer (4c) and including a third CNF different from the first CNF of the first layer (4a). For example, the first layer (4a) and the fifth layer (4e) may each independently include a microbial CNF, and the third layer (4c) may include, but is not limited to, at least one selected from a cross-linking agent, a binder, inorganic particles, inorganic fiber, polyamide nanofiber, and polyolefin, or any other materials in the art commonly used to form the porous film. The fifth layer (4e) may or may not further include polyolefin.

Referring to FIGS. 6A to 6I, at least one of the first layer (4a), the second layer (4b), the third layer (4c), the fourth layer (4d), and the fifth layer (4e) included in the porous film (4) may further include at least one selected from a cross-linking agent, a binder, inorganic particles, polyamide nanofiber, polyolefin-based porous film, heat-resistant aramid fiber, or heat-resistant polymer having elongation property such as polyimide, polyethylene terephthalate (PET), polyacrylonitrile (PAN), and polyvinylidene difluoride (PVDF).

In some embodiments of the present disclosure, a Gurley value per unit thickness of the porous film, corresponding to air permeability per unit thickness, may be about 30 sec/100 cc·μm or less, about 28 sec/100 cc·μm or less, about 26 sec/100 cc·μm or less, about 24 sec/100 cc·μm or less, about 22 sec/100 cc·μm or less, about 20 sec/100 cc·μm or less, about 18 sec/100 cc·μm or less, about 16 sec/100 cc·μm or less, about 14 sec/100 cc·μm or less, about 12 sec/100 cc·μm or less, or about 10 sec/100 cc·μm or less. The Gurley value per unit thickness of the porous film, corresponding to air permeability per unit thickness may be, for example, about 5 sec/100 cc·μm or greater, about 6 sec/100 cc·μm or greater, about 7 sec/100 cc·μm or greater, or about 8 sec/100 cc·μm or greater. Air permeability may be obtained using a method according to JIS P8117. The Gurley value is time (sec) taken for 100 cc of air to pass through the porous film. The Gurley value per unit thickness is obtained by dividing the Gurley value by a thickness of the porous film.

The porous film may have any suitable thickness, such as a thickness of about 5 μm or greater. For example, the thickness of the porous film may be from about 5 μm to about 500 μm, from about 5 μm to about 450 μm, from about 5 μm to about 400 μm, from about 5 μm to about 350 μm, from about 5 μm to about 300 μm, from about 5 μm to about 250 μm, from about 5 μm to about 200 μm, from about 5 μm to about 150 μm, from about 5 μm to about 100 μm, from about 5 μm to about 80 μm, from about 5 μm to about 60 μm, from about 5 μm to about 40 μm, or from about 5 μm to about 30 μm. When the thickness of the porous film decreases below the ranges disclosed herein, the mechanical properties of the porous film may deteriorate. Thus, the porous film may break while a lithium battery using the porous film as a separator is assembled, or the porous film may be damaged by lithium dendrites that grow during charging and discharging of the lithium battery, thereby causing deterioration of the lithium battery. When the thickness of the porous film increases above the ranges disclosed herein, cycle characteristics of a lithium battery using the porous film as a separator may deteriorate due to increased internal resistance of the lithium battery, and energy density per unit volume of the lithium battery may decrease due to an increase in volume of the lithium battery. Thus, the thickness of the lithium battery including the porous film of the present disclosure provides for improved energy density per unit volume of the lithium battery.

In some embodiments, the Gurley value of the porous film, corresponding to air permeability, may be from about 50 sec/100 cc to about 800 sec/100 cc, from about 50 sec/100 cc to about 750 sec/100 cc, from about 50 sec/100 cc to about 700 sec/100 cc, from about 50 sec/100 cc to about 650 sec/100 cc, from about 50 sec/100 cc to about 600 sec/100 cc, from about 50 sec/100 cc to about 550 sec/100 cc, from about 50 sec/100 cc to about 500 sec/100 cc, from about 50 sec/100 cc to about 450 sec/100 cc, from about 50 sec/100 cc to about 400 sec/100 cc, from about 50 sec/100 cc to about 350 sec/100 cc, or from about 50 sec/100 cc to about 300 sec/100 cc. The Gurley value is measured using a method according to JIS P8117. When the Gurley value decreases, lithium may easily be precipitated in pores of the porous film. Thus, when a porous film having a very low Gurley value is used as a separator for lithium batteries, lithium-blocking properties may deteriorate, thereby facilitating the formation of lithium dendrites, which may cause short circuiting. When the Gurley value of a porous film increases, transmission of lithium ions via the porous film may be interrupted. Thus, when a porous film having a very high Gurley value is used as a separator for lithium batteries, internal resistance of the lithium batteries increases, thereby deteriorating cycle characteristics of the lithium batteries.

The porous film of the present disclosure may have a uniform Gurley value over the entire area of the porous film. When the porous film has uniform air permeability, current density may uniformly be distributed in an electrode of a lithium battery including the porous film as a separator, and thus side reactions such as precipitation of crystals at an interface between the electrode and the electrolyte may be prevented.

The porous film according to one or more embodiments may have, for example, a porosity of from about 10% to about 90%, from about 15% to about 85%, from about 20% to about 80%, from about 25% to about 80%, from about 30% to about 80%, from about 35% to about 80%, from about 35% to about 75%, or from about 40% to about 75%. Although operation of an electrochemical device comprising a separator comprising a porous film having a porosity of less than 10% is possible, performance thereof may deteriorate due to low output characteristics caused by high internal resistance. When the porosity of the porous film is greater than 90%, internal resistance may decrease and output characteristics of the electrochemical device may be improved, for example, cycle characteristics of a lithium battery may be improved. However, the possibility of occurrence of short circuits by lithium dendrites may increase, thereby deteriorating stability. The porosity of the porous film may be measured by a liquid or gas adsorption method according to ASTM D-2873.

In some embodiments, the porous film may have a tensile strength of about 500 kgf/cm² or greater, about 550 kgf/cm² or greater, about 600 kgf/cm² or greater, about 650 kgf/cm² or greater, about 700 kgf/cm² or greater, about 750 kgf/cm² or greater, about 800 kgf/cm² or greater, about 850 kgf/cm² or greater, about 900 kgf/cm² or greater, or about 950 kgf/cm² or greater. For example, the tensile strength of the porous film may be from about 500 kgf/cm² to about 1000 kgf/cm², from about 500 kgf/cm² to about 950 kgf/cm², from about 500 kgf/cm² to about 900 kgf/cm², from about 500 kgf/cm² to about 850 kgf/cm², from about 500 kgf/cm² to about 800 kgf/cm², from about 500 kgf/cm² to about 750 kgf/cm², or from about 500 kgf/cm² to about 700 kgf/cm². When the tensile strength of the porous film is within these ranges, a minimum tensile strength required to manufacture winding-type batteries may be obtained, and pin-puncture strength may further be increased. Thus, when the porous film of the present disclosure is used as a separator, durability of the separator may be improved during charging and discharging of a lithium battery, and battery capacity may further be increased due to a decreased thickness of the separator. When the tensile strength of the porous film is less than about 500 kgf/cm², durability of the separator may deteriorate, a manufacturing yield may decrease due to breakage during a manufacturing process, and a winding-type battery may not be manufactured. Likewise, low pin-puncture strength may decrease to deteriorate durability, and battery capacity may decrease due to an increase in thickness to obtain a minimum tension.

In certain embodiments, the porous film may have a pin-puncture strength of about 70 kgf or greater, about 75 kgf or greater, about 80 kgf or greater, about 85 kgf or greater, about 90 kgf or greater, about 95 kgf or greater, or about 100 kgf or greater. For example, the pin-puncture strength of the porous film may be from about 70 kgf to about 150 kgf, from about 75 kgf to about 150 kgf, from about 80 kgf to about 150 kgf, from about 80 kgf to about 145 kgf, from about 85 kgf to about 140 kgf, from about 90 kgf to about 140 kgf, or from about 90 kgf to about 130 kgf/cm². When the porous film has a pin-puncture strength within the ranges above, short circuits caused by dendrites may efficiently be inhibited during charging and discharging. Thus, when the porous film of the present disclosure is used as a separator, durability of the separator may be improved during charging and discharging, and deterioration of a battery may be inhibited. Likewise, battery capacity may further be increased due to a decreased thickness of the separator. When the pin-puncture strength of the porous film is less than about 70 kgf, durability of the separator decreases, and thus the thickness of the separator to obtain a minimum pin-puncture strength increases, thereby decreasing battery capacity. Measurement of the pin-puncture strength of the porous film will be described below with reference to Evaluation Example 3.

A separator according to another embodiment includes the above-described porous film.

When used as a separator, the porous film allows ion transfer between electrodes and blocks electrical contact between the electrodes in an electrochemical device comprising the porous film as the separator, thereby improving performance of the electrochemical device. Also, side reactions between the porous film and an electrolyte may be inhibited, and/or deterioration of the electrochemical device may be suppressed. In other words, cycle characteristics of the electrochemical device may be improved.

An electrochemical device according to another embodiment includes: a positive electrode; a negative electrode; and a separator interposed between the positive electrode and the negative electrode. When the electrochemical device includes the separator described herein, deterioration of the electrochemical battery may be inhibited, and therefore lifespan characteristics thereof may be improved.

An electrochemical device according to a further embodiment may include: a positive electrode; a negative electrode; a separator comprising cellulose nanofibers or a derivative thereof (CNF) interposed between the positive electrode and the negative electrode; and an electrolyte including a lithium salt and a Lewis base.

Although the porous film into which the Lewis base is directly introduced may be used as a separator, a porous film or separator comprising CNF may instead, or in addition, be impregnated with an electrolyte after introducing the Lewis base into the electrolyte, such that the Lewis base inhibits carbonization of the separator comprising CNF.

The Lewis base introduced into the separator may be chemically or physically be bound to cellulose or the derivative thereof.

The Lewis base may be included in the electrolyte in an amount of from about 5% by weight to about 50% by weight based on a total weight of the electrolyte. For example, the amount of the Lewis base may be from about 10% by weight to about 50% by weight, from about 20% by weight to about 50% by weight, or from about 30% by weight to about 50% by weight based on the total weight of the electrolyte. When the amount of the Lewis base is within the ranges above, the Lewis base is infiltrated into the separator, and thus, carbonization of the nanofiber including cellulose or a derivative thereof may be inhibited.

The Lewis base may be added to the porous film directly, rather than from the electrolyte. In this case, an amount of the Lewis base may be in a range of more than 0 part by weight and equal to or less than about 100 parts by weight based on 100 parts by weight of the CNF. For example, an amount of the Lewis base may be in a range of from about 10 parts by weight to about 90 parts by weight, from about 20 parts by weight to about 80 parts by weight, or from about 30 parts by weight to about 70 parts by weight based on 100 parts by weight of the CNF. When the amount of the Lewis base is within the ranges above, the Lewis base is infiltrated into the separator, and thus, carbonization of the nanofiber including cellulose or a derivative thereof may be inhibited.

The lithium salt included in the electrolyte may include at least one selected from LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, (CF₃SO₂)₂NLi, lithium chloroborate, lower aliphatic lithium carboxylate, lithium tetraphenyl borate, and lithium imide. However, the embodiment is not limited thereto, and any lithium salt commonly used in the art may also be used.

In one embodiment, the porous film may include LiPF₆ as the lithium salt.

In some embodiments, the electrolyte may be a liquid electrolyte.

The liquid electrolyte may be prepared by dissolving a lithium salt in an organic solvent.

Any organic solvent commonly used in the art may be used to dissolve the lithium salt. For example, the organic solvent may be propylene carbonate, ethylene carbonate, fluoroethylene carbonate, butylene carbonate, dimethyl carbonate, diethyl carbonate, methylethyl carbonate, methylpropyl carbonate, ethylpropyl carbonate, methylisopropyl carbonate, dipropyl carbonate, dibutyl carbonate, benzonitrile, acetonitrile, tetrahydrofuran, 2-methyltetrahydrofuran, γ-butyrolactone, dioxorane, 4-methyldioxorane, N,N-dimethyl formamide, dimethyl acetamide, dimethylsulfoxide, dioxane, 1,2-dimethoxyethane, sulforane, dichloroethane, chlorobenzene, nitrobenzene, diethylene glycol, dimethyl ether, or any mixtures thereof.

The electrochemical device is not particularly limited and any known device capable of storing and/or releasing electricity via electrochemical reactions may also be used. For example, the electrochemical device may be an electrochemical battery or an electric double layer capacitor. Examples of the electrochemical battery may include alkali metal batteries such as lithium batteries and sodium batteries and fuel cells. The electrochemical battery may be a primary battery or a rechargeable secondary battery. The lithium batteries may be lithium-ion batteries, lithium polymer batteries, lithium sulfur batteries, lithium metal batteries, lithium air batteries, or the like.

A lithium battery may be manufactured according to the following method, but the embodiment is not limited thereto, and any other method enabling operation of the lithium battery may also be used.

First, a negative electrode may be prepared according to a method of manufacturing the negative electrode.

In one embodiment, the negative electrode is prepared by mixing a negative active material, a conductive material, a binder, and a solvent to prepare a negative active material composition. The negative active material composition may then be directly coated on a current collector such as a copper foil to prepare a negative electrode plate. Alternatively, the negative active material composition may be cast on a separate support, and then a film separated from the support may be laminated on the copper current collect to prepare a negative electrode plate. However, the negative electrode is not limited thereto and may have any other shape.

The negative active material may be any material commonly used in the art as a negative active material of a lithium battery. For example, the negative active material may include at least one selected from lithium metal, metal alloyable with lithium, a transition metal oxide, a non-transition metal oxide, and a carbonaceous material.

For example, the metal alloyable with lithium may be Si, Sn, Al, Ge, Pb, Bi, Sb, an Si—Y alloy (where Y is alkali metal, alkali earth metal, a Group XIII element, a Group XIV element, transition metal, a rare earth element, or any combination thereof (except for Si)), or an Sn—Y alloy (where Y is alkali metal, alkali earth metal, a Group XIII element, a Group XIV element, transition metal, rare earth element, or any combination thereof (except for Sn)). In this regard, the element Y may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or any combination thereof.

For example, the transition metal oxide may be lithium titanium oxide, vanadium oxide, lithium vanadium oxide, or the like.

For example, the non-transition metal oxide may be SnO₂, SiOₓ (0<x<2), or the like.

The carbonaceous material may include crystalline carbon, amorphous carbon, or any mixture thereof. Examples of the crystalline carbon include graphite such as natural graphite or artificial graphite in amorphous, plate, flake, spherical or fibrous form. Examples of the amorphous carbon include soft carbon (carbon calcined at low temperature), hard carbon, mesophase pitch carbides, calcined corks, and the like.

Examples of the conductive material may include acetylene black, natural graphite, artificial graphite, carbon black, Ketjen black, carbon fiber, and metal such as copper, nickel, aluminum, and silver in powder form or fiber form. Alternatively, at least one conductive material such as a polyphenylene derivative may be used, without being limited thereto. Any conductive material commonly used in the art may also be used. Also, the above-described carbonaceous material may be used as the conductive material.

Examples of the binder may include, but are not limited to, a vinylidene fluoride/hexafluoropropylene copolymer, polyvinylidene fluoride (PVDF), polyacrylonitrile, polymethylmethacrylate, polytetrafluoroethylene, mixtures thereof, and a styrene butadiene rubber polymer, and any other binder commonly used in the art may also be used.

Examples of the solvent include, but are not limited to, N-methyl-pyrrolidone, acetone, and water, and any other solvent commonly used in the art may also be used.

The amounts of the negative active material, the conductive material, the binder, and the solvent are amounts commonly used in the manufacture of the lithium battery. At least one of the conductive material and the solvent may not be used according to the use and the structure of the lithium battery

The positive electrode of the present disclosure may be prepared according to the following method of manufacturing the positive electrode.

The positive electrode may be prepared in the same manner as in the preparation of the negative electrode, except that a positive active material is used instead of the negative active material. Also, the conductive material, the binder, and the solvent of the positive active material composition may be the same as or different from those of the negative electrode.

For example, a positive active material, a conductive material, a binder, and a solvent may be mixed to prepare a positive active material composition. The positive active material composition may be directly coated on an aluminum current collector to prepare a positive electrode plate. Alternatively, the positive active material composition may be cast on a separate support, and then a film separated from the support may be laminated on the aluminum current collect to prepare a positive electrode plate. However, the positive electrode is not limited thereto and may have any other shape.

Examples of the positive active material may include, but are not limited to, at least one selected from lithium cobalt oxide, lithium nickel cobalt manganese oxide, lithium nickel cobalt aluminum oxide, lithium iron phosphate, and lithium manganese oxide, and any positive active material commonly used in the art.

Examples of the positive active material may include one of the compounds represented by the following formulae: LiₐA_{1-b}B_{b}D₂ (where 0.90≤a≤1.8 and 0≤b≤0.5); LiₐE_{1-b}B_{b}O_{2-c}D_{c} (where 0.90≤a≤1.8, 0≤b≤0.5, and 0≤c≤0.05); LiE_{2-b}B_{b}O_{4-c}D_{c} (where 0≤b≤0.5 and 0≤c≤0.05); LiₐNi_{1-b-c}Co_{b}B_{c}D_{α} (where 0.90≤a≤1.8, 0≤b≤0.5, 0≤c≤0.05, and 0<α≤2); LiₐNi_{1-b-c}Co_{b}B_{c}O_{2-α}F_{α} (where 0.90≤a≤1.8, 0≤b≤0.5, 0≤c≤0.05, and 0<α<2); LiₐNi_{1-b-c}CO_{b}B_{c}O_{2-α}F₂ (where 0.90≤a≤1.8, 0≤b≤0.05, 0≤c≤0.05, and 0<α<2); LiₐNi_{1-b-c}Mn_{b}B_{c}D_{α} (where 0.90≤a≤1.8, 0≤b≤0.5, 0≤c≤0.05, and 0<α≤2); LiₐNi_{1-b-c}Mn_{b}B_{c}O_{2-α}F_{α} (where 0.90≤a≤1.8, 0≤b≤0.5, 0≤c≤0.05, and 0<α<2); LiₐNi_{1-b-c}Mn_{b}B_{c}O_{2-α}F₂ (where 0.90≤α≤1.8, 0≤b≤0.5, 0≤c≤0.05, and 0<α<2); LiₐNi_{b}E_{c}G_{d}O₂ (where 0.90≤a≤1.8, 0≤b≤0.9, 0≤c≤0.5, and 0.001≤d≤0.1); LiₐNi_{b}Co_{c}Mn_{d}GeO₂ (where 0.90≤a≤1.8, 0≤b≤0.9, 0≤c≤0.5, and 0.001≤e≤0.1); LiₐNiG_{b}O₂ (where 0.90≤a≤1.8 and 0.001≤b≤0.1); LiₐCoG_{b}O₂ (where 0.90≤a≤1.8 and 0.001≤b≤0.1); LiₐMnG_{b}O₂ (where 0.90≤a≤1.8 and 0.001≤b≤0.1); LiₐMn₂G_{b}O₄ (where 0.90≤a≤1.8 and 0.001≤b≤0.1); QO₂; QS₂; LiQS₂; V₂O₅; LiV₂O₅; LiIO₂; LiNiVO₄; Li_{(3-f)}J₂(PO₄)₃ (0≤f≤2); Li_{(3-f)}Fe₂(PO₄)₃ (0≤f≤2); and LiFePO₄.

In the formulae, A may be Ni, Co, Mn, or any combination thereof; B may be Al, Ni, Co, Mn, Cr, Fe, Mg, Sr, V, a rear earth element, or any combination thereof; D may be O, F, S, P, or any combination thereof; E may be Co, Mn, or any combination thereof; F may be F, S, P, or any combination thereof; G may be Al, Cr, Mn, Fe, Mg, La, Ce, Sr, V, or any combination thereof; Q may be Ti, Mo, Mn, or any combination thereof; I may be Cr, V, Fe, Sc, Y, or any combination thereof; and J may be V, Cr, Mn, Co, Ni, Cu, or any combination thereof.

In some embodiments, the positive active material may be a composite compound having a coating layer added to the surface of the compound, or a mixture of the compound lacking the coating later and the compound having a coating layer. The coating layer may comprise a compound such as an oxide, hydroxide, oxyhydroxide, oxycarbonate, or hydroxycarbonate of a coating element. The compound included in the coating layer, i.e., the coating element, may be amorphous or crystalline. Examples of the coating element included in the coating layer may be Mg, Al, Co, K, Na, Ca, Si, Ti, V, Sn, Ge, Ga, B, As, Zr, or any mixture thereof. The coating layer may be added to the compound by using any method known in the art, which does not adversely affect the physical properties of the positive active material. For example, the coating method may be a spray coating method or an immersion method. These coating methods are well known in the art, and thus detailed descriptions thereof will be omitted.

For example, the positive active material may be LiNiO₂, LiCoO₂, LiMnₓO₂ₓ (x=1 or 2), LiNi₁₋ₓMnₓO₂ (0<x<1), LiNi_{1-x-y}CoₓMn_{y}O₂ (0≤x≤0.5 and 0≤y≤0.5), LiFePO₄, or the like.

Subsequently, the separator described herein may be interposed between the positive electrode and the negative electrode.

An electrolyte may also be prepared according to one embodiment of the present disclosure.

The electrolyte may be an organic electrolyte. Alternatively, the electrolyte may be a solid electrolyte. Examples of the solid electrolyte may include, but are not limited to, boron oxide and lithium oxynitride, and any compound available in the art as a solid electrolyte. The solid electrolyte may be located on the negative electrode by sputtering, atomic layer deposition (ALD), chemical vapor deposition (CVD), physical vapor deposition (PVD), or the like.

In further embodiments, an organic electrolyte is prepared. The organic electrolyte is prepared by dissolving a lithium salt in an organic solvent.

The organic solvent may be any organic solvent commonly used in the art.

Examples of the organic solvent include propylene carbonate, ethylene carbonate, fluoroethylene carbonate, butylene carbonate, dimethyl carbonate, diethyl carbonate, methylethyl carbonate, methylpropyl carbonate, ethylpropyl carbonate, methylisopropyl carbonate, dipropyl carbonate, dibutyl carbonate, benzonitrile, acetonitrile, tetrahydrofuran, 2-m ethyltetrahydrofuran, γ-butyrolactone, dioxorane, 4-methyldioxorane, N,N-dimethyl formamide, dimethyl acetamide, dimethylsulfoxide, dioxane, 1,2-dimethoxyethane, sulforane, dichloroethane, chlorobenzene, nitrobenzene, diethylene glycol, dimethyl ether, and mixtures thereof.

The lithium salt may be any lithium salt commonly used in the art. Examples of the lithium salt may include LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LiN(CₓF₂ₓ₊₁SO₂)(C_{y}F_{2y+1}SO₂) (where x and y are natural numbers), LiCl, LiI, or any mixture thereof.

Lithium batteries may be classified as lithium ion batteries, lithium ion polymer batteries, and lithium polymer batteries according to types of the separator and the electrolyte. Lithium batteries may also be classified into a cylindrical type, a rectangular type, a coin type, and a pouch type according to the shape of the battery, and classified into a bulk type and a thin film type according to the size of the battery. Lithium batteries may be used either as primary lithium batteries or secondary lithium batteries.

The lithium battery may be a lithium ion battery. The lithium battery may be a lithium ion battery having a charge voltage of 4.3 V or greater.

The lithium battery may be suitable for use as power sources for devices requiring high capacity, high output, and high temperature conditions for operations, such as electric vehicles as well as power sources for mobile phones and portable computers. The lithium battery may also be used in hybrid vehicles, coupled to internal combustion engines, fuel cells, super-capacitors, or the like. Embodiments are not limited thereto. The lithium battery of the present disclosure may be used in any application requiring high-power output, high voltage, and high temperature conditions for operations.

Methods of preparing these batteries are well known in the art, and thus detailed descriptions thereof will not be provided.

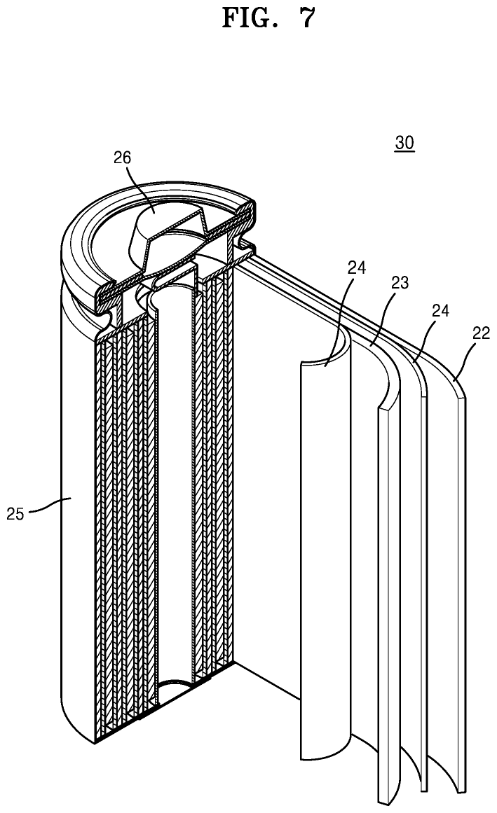

FIG. 7 is a diagram schematically illustrating a structure of a lithium battery according to one embodiment.

Referring to FIG. 7, a lithium battery (30) includes a positive electrode (23), a negative electrode (22), and a separator (24) interposed between the positive electrode (23) and the negative electrode (22). The positive electrode (23), the negative electrode (22), and the separator (24) are wound or folded, and then encapsulated in a battery case (25). Then, an electrolyte is injected into the battery case (25) and the battery case (25) is sealed by a sealing member (26), thereby completing the manufacture of the lithium battery (30). The battery case (25) may have a cylindrical shape, a rectangular shape, or a thin-film shape.

According to one embodiment, the separator may be interposed between the positive electrode and the negative electrode to form a battery assembly. The battery assembly may be stacked in a bi-cell structure and impregnated in an organic electrolyte, subsequently encapsulated in a pouch, and sealed to complete manufacture of the lithium battery.

In some embodiments, a plurality of battery assemblies may be stacked to form a battery pack, and the battery pack may be used in any device that requires high capacity and high output. For example, the battery pack may be used in notebook computers, smart phones, and electric vehicles.

Particularly, the lithium battery of the present disclosure is suitable for electric vehicles (EVs) due to excellent rate properties and lifespan characteristics. For example, the lithium battery is suitable for hybrid electric vehicles such as plug-in hybrid electric vehicle (PHEVs).

Hereinafter, one or more embodiments of the present disclosure will be described in detail with reference to the following examples. These examples are not intended to limit the purpose and scope of the one or more embodiments of the present disclosure.

### Example 1

A microbial cellulose nanofiber (CNF) nonwoven fabric was prepared as follows using propylene carbonate (PC) as a pore former.

Microbial cellulose was obtained by culturing a wild-type Gluconacetobacter xylinum strain. Particularly, the wild-type Gluconacetobacter xylinum strain was added to 700 ml of a Hestrin-Schramm (HS) medium supplemented with 1% to 2% of carboxymethyl cellulose (CMC), and the medium was then incubated while stirring at 30° C. for 48 hours at 250 rpm to obtain a fermented solution including cellulose. For further dispersion, the fermented solution including the CNF was passed twice through a microchannel (Interaction chamber, size 200 μm) of a Nano Disperser (Ilshin Autoclave Co. Ltd., ISA-NH500, Korea), which is a high pressure homogenizer, at a pressure of 70 MPa. The resultant was treated with 0.1 N NaOH at 90° C. to remove cells and impurities and washed with distilled water to obtain a suspension including purified CNF.

To prepare a porous nonwoven fabric, CMC (20 wt % based on 100 wt % of CNF) and PC (2 wt % based on total suspension) were added to purified CNF and the mixture was diluted using distilled water, such that an amount of CNF was 0.5 wt % based on the total weight of the suspension, to prepare a coating solution.

The coating solution was applied to a polyester film to a thickness of 1.2 mm by using a micrometer adjustable applicator and dried in an oven at 85° C. for 3 hours to prepare a CNF nonwoven fabric.

Subsequently, solutions were prepared by adding 0, 10, 20, and 30 wt % of tris(2,2,2-trifluoroethyl)phosphite (TTFP), as a Lewis base, to a carbonate-based mixed solvent [ethylene carbonate (EC):ethyl methyl carbonate (EMC):dimethyl carbonate (DMC)=2:4:4 (vol %)], in which 1.15 M of LiPF₆ was dissolved, respectively.

Finally, the solutions were added to the CNF nonwoven fabric to prepare a CNF porous films including the Lewis base.

In this regard, the CNF nonwoven fabric was cut to a size of 5×5 cm and placed on Petri dishes, and 300 μm of each solution was added thereto to sufficiently wet the fabric to prepare the CNF porous film for evaluations described below in Evaluation Examples 1 and 2.

### Example 2

A CNF porous film was prepared in the same manner as in Example 1, except that a polymer of poly(ethylene glycol) (PEG) was added to the solution in an amount of 30 wt % as the Lewis base.

### Example 3

A CNF porous film was prepared in the same manner as in Example 1, except that hexamethylphosphoramide (HMPA) was added to the solution in an amount of 30 wt % as the Lewis base.

### Evaluation Example 1: Evaluation of Thermal Deformation

To evaluate thermal deformation of the prepared CNF porous film, the Petri dishes in which the CNF porous films prepared according to Example 1 were placed were covered with lids and incubated in a furnace at 170° C. for 15 minutes, and then colors and physical properties thereof were observed.

FIG. 2 shows results of observing changes in colors and physical properties of the CNF porous films with respect to amounts of the Lewis base. Referring to FIG. 2, it was confirmed that carbonization of the CNF porous film decreased as the amount of the Lewis base (i.e., TTFP) increased.

The CNF porous film prepared according to Example 2 was subjected to the same thermal deformation evaluation, and the results are shown in FIG. 3. Referring to FIG. 3, it was confirmed that carbonation of the CNF porous film was inhibited when a Lewis base polymer (i.e., PEG), was added, as compared to a case in which the Lewis base polymer was not added.

### Evaluation Example 2: Evaluation of Mechanical Properties with Respect to Temperature

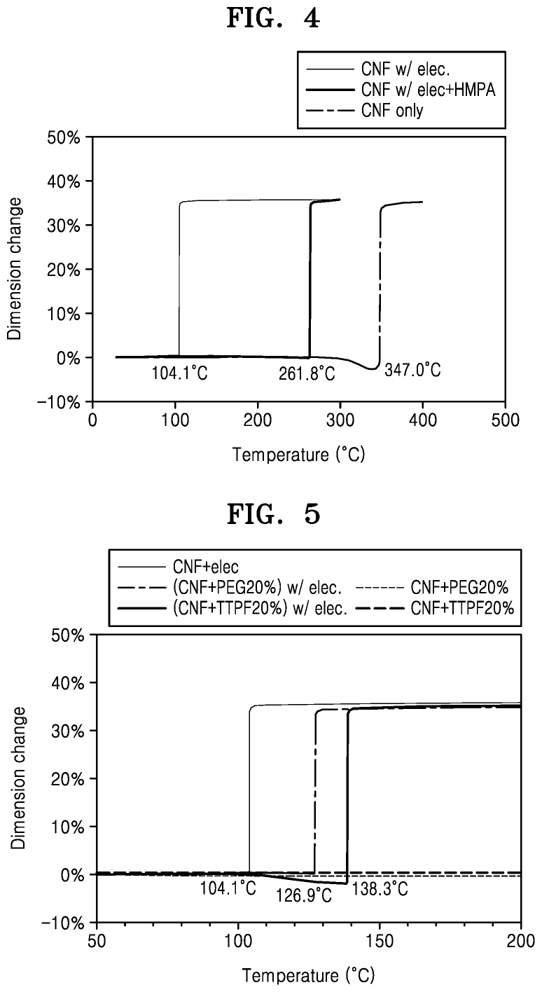

To evaluate changes in mechanical properties of the CNF porous film with respect to temperature, the CNF porous film prepared according to Example 3 was subjected to thermo mechanical analysis (TMA), and results are shown in FIG. 4. FIG. 4 illustrates TMA results of the CNF nonwoven fabric and TMA results of the CNF porous film wet by the electrolyte not including a Lewis base.

TMA was performed by measuring a variation (%) of a length of the porous film with respect to temperature while raising the temperature at a rate of 10° C./min using a TMA Q400 (Waters) in a state where a tension of 0.05 N was applied thereto.

As a result of comparing temperatures at which changes in mechanical properties were observed with respect to an increase in temperature via TMA analysis, mechanical properties of the CNF nonwoven fabric were changed at 347° C. as shown in FIG. 4. When heated with the electrolyte to which a Lewis base was not added, deformation temperature of the CNF porous film decreased from 347° C. to about 104° C. However, when HMPA was added to the electrolyte as a Lewis base, a deformation temperature of the CNF porous film returned to about 261° C. from about 104° C.

### Example 4

To directly introduce a Lewis base into the CNF porous film, CMC (20 wt % based on 100 wt % of CNF), PC (2 wt % based on total suspension), and each of 10 wt %, 20 wt %, and 50 wt % (based on 100 wt % of CNF) of PEG, as the Lewis base, were added to purified CNF, and the mixture was diluted using distilled water, such that an amount of CNF based on the total weight of the suspension was 0.5 wt %, to prepare a coating solution. The prepared coating solution was subjected to the same process as that of Example 1 to prepare CNF porous films including PEG as the Lewis base.

### Example 5

CNF porous films were prepared in the same manner as in Example 4, except that 10 wt %, 20 wt %, and 50 wt % (based on 100 wt % of CNF) of TTFP were added as the Lewis base, respectively.

### Evaluation Example 3: Evaluation of Air Permeability and Mechanical Properties

Thickness, pin-puncture strength, and tensile strength of the CNF porous films to which the Lewis base was added and not added prepared according to Examples 4 and 5 respectively were measured, and results thereof are shown in Table 1 below.

The thickness of the porous film was obtained by measuring thicknesses of a separator sample having a size of 15 mm×50 mm at five points by using a TM600 (Kumagai Riki Industry Co., Ltd.) and calculating an average thereof.

The Gurley value, i.e., air permeability, of the porous film was measured by using a permeability tester (E-Globaledge Corporation, EGO-1-55-1MR, Oken Type Air Permeability Tester) according to JIS P8117. The Gurley value is time (sec) taken for 100 cc of air to pass through the porous film. As the air passes through the porous film more smoothly, the Gurley value decreases.

The pin-puncture strength was measured as a force applied to punch a hole having a diameter of 10 cm in the porous film (having an area of 15 mm×50 mm) using a Kato tech NDG5 tester while pressing with a 1 mm probe.

The tensile strength was measured using tensile modulus and stress at break in a stress-strain curve obtained by pulling a sample at a speed of 5 mm/min by using a Texture analyzer (TA.XT plus, Stable Micro Systems).

TABLE 1

| | | | Air | Pin-puncture | Tensile |
|---|---|---|---|---|---|
| | | Thickness | Permeability | Strength | Strength |
| | | (μm) | (sec/100 cm³) | (g · f) | (kg · f/cm²) |
| CNF only | | 14 | 172 | 55.7 | 404.3 |
| PEG | 10 wt % | 14 | 186 | 50.4 | 368.5 |
| | 20 wt % | 16 | 224 | 57.6 | 350.1 |
| | 50 wt % | 18 | 519.5 | 64.3 | 320.2 |
| TTFP | 10 wt % | 15 | 156 | 54.9 | 351.3 |
| | 20 wt % | 17 | 172 | 53.2 | 281.3 |
| | 50 wt % | 20 | 171 | 55.5 | 211 |

As shown in Table 1, PEG has excellent miscibility with CNF during formation of the CNF porous film. Although air permeability slightly decreases by adding PEG, mechanical properties may be maintained until the amount of PEG reaches about 20 wt %.

As further shown in Table 1, air permeability was maintained even when 50 wt % of highly basic TTFP was added during formation of the CNF porous film, and the other mechanical properties were well maintained until the amount of TTFP reached about 20 wt %.

### Evaluation Example 4: Evaluation of Mechanical Properties with Respect to Temperature

The CNF porous films with or without the Lewis base prepared according to Examples 4 and 5 were subjected to TMA, and results are shown in FIG. 5. FIG. 5 illustrates both TMA results of the CNF porous film into which the Lewis base was not introduced and TMA results of the CNF porous film into which the Lewis base was introduced.

TMA analysis was performed in the same manner as in Evaluation Example 2.

As illustrated in FIG. 5, a temperature at which changes of mechanical properties were observed was about 104° C. in the case of the CNF porous film into which the Lewis base was not introduced. It was confirmed that a temperature at which changes of mechanical properties of the CNF porous film were observed increased when the Lewis base was introduced into the CNF porous film, as compared to the case into which the Lewis base was not introduced (PEG: +22.8° C., TTFP: +34.2° C.).

Therefore, thermal stability may be improved by introducing an electrolyte comprising the Lewis base into the porous film during formation of the porous film.

The porous film according to one embodiment comprises a Lewis base and nanofibers including cellulose or a derivative thereof (CNF), such that thermal stability may be improved in a battery, thereby preventing thermochemical deformation of the battery. The electrochemical device comprising the separator comprising the porous film also has improved thermal stability, and thus deterioration thereof may be inhibited.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of the disclosure (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosed subject matter and does not pose a limitation on the scope of the disclosure unless otherwise claimed. No language in the specification should be construed as indicating any non-claimed element as essential to the practice of the subject matter disclosed herein.

Embodiments are described herein, including the best mode of operation. Variations of those embodiments may become apparent to those of ordinary skill in the art upon reading the foregoing description, and such variations are contemplated by applicant. Accordingly, disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. A porous film comprising:
a Lewis base; and
nanofibers comprising cellulose or a derivative thereof.

2. The porous film of claim 1, wherein the Lewis base is a compound comprising a functional group having an atom which has an unshared electron pair as an electron pair donor.

3. The porous film of claim 1, wherein the Lewis base comprises at least one selected from hexamethylphosphoramide (HMPA), tris(2,2,2-trifluoroethyl) phosphate (TTFP), polyethylene glycol (PEG), polyethylenimine (PEI), poly(vinyl acetate) (PVAc), N,N-dimethylacetamide (DMAc), hexamethoxycyclotriphosphazene (HMPN), pyridine, dimethylsulfoxide (DMSO), N-methyl-2-pyrrolidione, N-methyl-2-pyridine, 2,6-dimethyl-γ-pyrone, acetamide, urea, thiourea, N,N-dimethylthioacetamide, thioacetamide, ethylenediamine, tetramethylethylenediamine, 2,2′-bipyridine, 1,10-piperidine, aniline, pyrrolidine, diethylamine, N-methylpyrrolidine, n-propylamine, and a derivative thereof.

4. The porous film of claim 1, wherein the Lewis base forms a complex with a decomposition product of LiPF₆.

5. The porous film of claim 4, wherein the decomposition product of LiPF₆ is PF₅.

6. The porous film of claim 1, wherein the at least one Lewis base is chemically or physically bound to the cellulose or the derivative thereof.

7. The porous film of claim 1, wherein the porous film has a thickness of 5 μm or greater and an air permeability per unit thickness of 30 sec/100 cc·μm or less.

8. The porous film of claim 1, wherein the nanofibers of the cellulose or the derivative thereof are in the form of a nonwoven fabric, and the Lewis base is incorporated to the nonwoven fabric.

9. The porous film of claim 1, wherein the porous film is impregnated with an electrolyte comprising a lithium salt.

10. The porous film of claim 9, wherein the at least one lithium salt comprises at least one selected from LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, (CF₃SO₂)₂NLi, lithium chloroborate, lower aliphatic lithium carboxylate, lithium tetraphenyl borate, and lithium imide.

11. The porous film of claim 9, wherein the lithium salt comprises LiPF₆.

12. A separator comprising the porous film according to claim 1.

13. An electrochemical device comprising:
a positive electrode;
a negative electrode; and
the separator according to claim 12 interposed between the positive electrode and the negative electrode.
